(19) United States
(12) Patent Application Publication
(10) Pub. No.: US 2010/0049691 A1
(43) Pub. Date: Feb. 25, 2010

(54) DATA STORAGE APPARATUS

(75) Inventors: Akihiro Ueda, Kawasaki (JP); Kazuhiko USUI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/541,533

(22) Filed: Aug. 14, 2009

(30) Foreign Application Priority Data
Aug. 21, 2008 (JP) 2008-212829

(51) Int. Cl. G06F 17/30

(52) U.S. Cl. 707/1; 707/E17.001

(57) ABSTRACT

An apparatus for storing data, the apparatus connectable to another apparatus via a plurality of paths over a network, includes: a plurality of ports each of which is connectable to one end of each of the paths; a memory for storing information of the plurality of paths to the another apparatus; and a processor for executing a process including: monitoring throughput of each of the plurality of paths by receiving a message from the another apparatus indicative of an amount of data successfully received at an interval, determining at least one of the ports for transmitting data on the basis of the monitored throughput, and transmitting data from the determined port to the another apparatus.

### CROSS-REFERENCE TO RELATED APPLICATION

This application is based upon and claims the benefit of priority of the prior Japanese Patent Application No. 2008-212829, filed on Aug. 21, 2008 the entire contents of which are incorporated herein by reference.

### FIELD

The embodiment herein is related to a storage apparatus for storing data.

### BACKGROUND

In a storage system, a server is connected to a storage apparatus through a network. A storage apparatus for storing data is available as one of information processing apparatuses. The storage system can copy data stored in one storage apparatus to other storage apparatus to improve data protection reliability. The storage apparatus has a function for copying the data stored in a disk apparatus between storage apparatuses without passing through a server. The storage apparatus executes a copy through networks such as a fibre channel, iSCSI, and the like.

The network such as the fibre channel, the iSCSI, and the like between a copy source storage apparatus and a copy destination storage apparatus transfers not only the data between the copy source storage apparatus and the copy destination storage apparatus but also the data used by other storage apparatus in the storage system or other server. Therefore, the throughput between the copy source storage apparatus and the copy destination storage apparatus is changed by the amount of other data to be transferred. A plurality of ports ordinarily connect between the storage apparatuses. The copy source storage apparatus transmits data to the copy destination storage apparatus according to the amount of data being transmitted by the respective ports. However, since the copy source storage apparatus selects a port according to the amount of data being transmitted, it may select a port having a small throughput. Related arts are disclosed in the Japanese Laid-open Patent Publication No. 2006-252202 and Japanese Laid-open Patent Publication No. 2000-224172.

### SUMMARY

According to an aspect of the invention, an apparatus for storing data, the apparatus connectable to another apparatus via a plurality of paths over a network, includes: a plurality of ports each of which is connectable to one end of each of the paths; a memory for storing information of the plurality of paths to the another apparatus; and a processor for executing a process including: monitoring throughput of each of the plurality of paths by receiving a message from the another apparatus indicative of an amount of data successfully received at an interval, determining at least one of the ports for transmitting data on the basis of the monitored throughput, and transmitting data from the determined port to the another apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view explaining an outline of an embodiment of the present invention.

FIG. 2 illustrates an arrangement of a storage system of the embodiment.

FIG. 3 is a flowchart of a throughput detection process.

FIG. 4 is an arrangement example of a table 170 for storing the relation between a path and a throughput.

FIG. 5 is a flowchart of a transfer path selection process.

FIG. 6 is a flowchart of a transfer efficiency degradation value detection process.

FIG. 7 is a flowchart of a transfer path selection process.

FIG. 8 is an arrangement example of a table illustrating the total value of an amount of data being transmitted and a transfer efficiency degradation value.

### DESCRIPTION OF EMBODIMENT

Embodiments of the present invention will be explained below with referring to drawings.

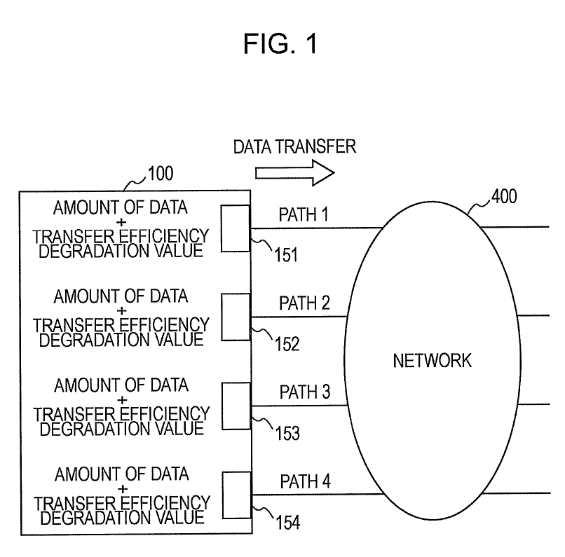

FIG. 1 is a view explaining an outline of the embodiment of the present invention. “A transfer efficiency degradation value” of FIG. 1 is a value set according to the value of a throughput. “An amount of data” of FIG. 1 illustrates an amount of data being transmitted. The amount of data being transmitted is the difference between the amount of transmitted data and the amount of data the transmission completion report of which is obtained. Paths of FIG. 1 are connected to a copy destination storage apparatus. In the embodiment, a copy source storage apparatus 100 periodically measures the throughputs of the paths through which data is transferred. The throughput is an effective transfer amount of data per unit time of a path. 151, 152, 153, and 154 denote ports connected to a network 400. The plurality of ports are connected to the copy destination storage apparatus through the plurality of paths. FIG. 1 illustrates a state that one path is set to one port. A plurality of paths may set to one port. The copy source storage apparatus selects a data transmission path according to the values of the throughputs of the respective paths. The copy destination storage apparatus is connected to the copy source storage apparatus through a plurality of paths. Note that it is assumed that the storage apparatus from which data to be copied is transmitted is the copy source storage apparatus. It is assumed that the storage apparatus to which data to be copied is transmitted is the copy destination storage apparatus.

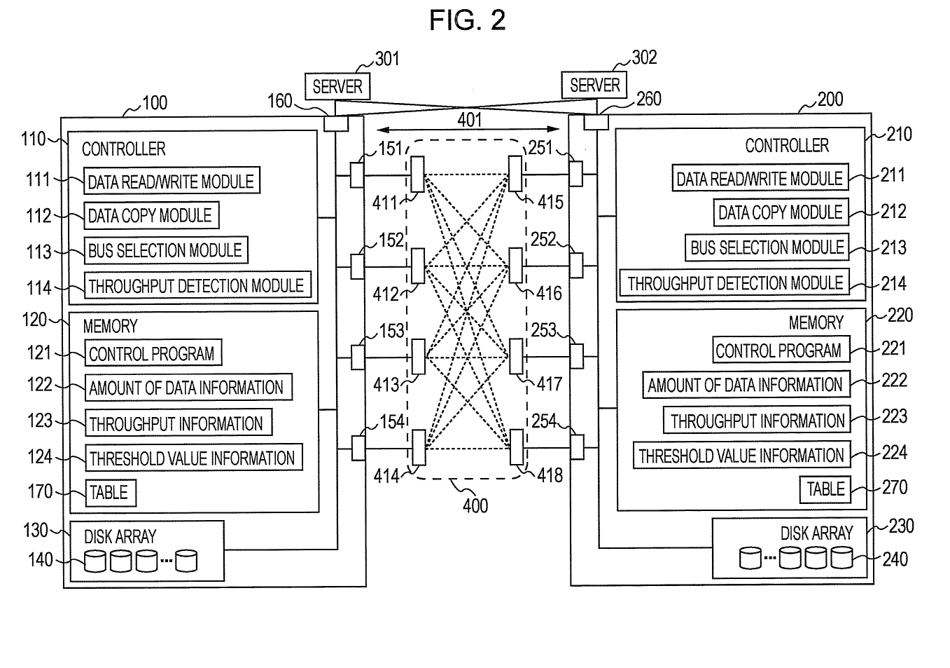

Since the copy source storage apparatus 100 transfers data using a path other than the paths which are temporarily placed in a busy state, it can reduce the loads of the temporarily busy paths. Note that the copy source storage apparatus 100 can instruct the path, which returns from the busy state to an ordinary state, to transfer data. Since the copy source storage apparatus periodically checks the throughputs of the paths between storage apparatuses, it can select a data transmission path through which a copy process is executed between the storage apparatuses. As a result, the copy source storage apparatus can disperse a data transfer load according to an increase/decrease of the amount of data which can be transferred through respective paths.

[Storage System] FIG. 2 illustrates an arrangement of a storage system according to the embodiment. The storage system of the embodiment includes the storage apparatus 100, a storage apparatus 200, a server 301, and a server 302. The storage apparatus 100 is connected to the storage apparatus 200 through a network 400 using a protocol, for example, a storage area network (SAN), a fibre channel, iSCSI (internet Small Computer System Interface), and the like. The storage system may be connected to a storage apparatus geographically away therefrom. In this case, the storage apparatus may be connected through a Wide Area Network (WAN).

The storage system stores data by a storage apparatus for managing a plurality of disk apparatuses. The storage system improves data protection reliability by multiplying data by copying the data, which is stored in a disk apparatus managed by one storage apparatus, to other storage apparatus. The storage apparatus has a remote equivalent copy function (hereinafter, called REC) for copying data stored in a disk apparatus between storage apparatuses without passing through a high-order server. The REC can be executed through the fibre channel, the iSCSI, a fibre channel IP (FCIP), and the like. The network may connect a storage apparatus in a long distance using a dedicated line, an ordinary line employing a wavelength-division multiplex (WDM), and the like. The dedicated line is a dedicated data transmission line connecting two locations. A communication destination, to which the dedicated line is connected, is determined. The WDM is one of communication techniques using an optical fibre. An FCIP is a protocol for connecting a SAN located geographically away therefrom through an IP network. The FCIP capsulates a frame transmitted by, for example, a fibre channel protocol and transmits it through the IP network. An amount of transfer per unit time changes according to the types of a switch and a router of the WAN and the degree of busy of a network. 411, 412, 413, 414, 415, 416, 417, and 418 of FIG. 2 denote apparatuses having an FCIP function. The IP network connects between the apparatus 411, the apparatus 412, the apparatus 413, and the apparatus 414 are connected to the apparatus 415, the apparatus 416, the apparatus 417, and the apparatus 418, respectively. For example, the apparatus 411 may transmit a frame received from the storage apparatus 100 to the apparatus 415. At the time, the apparatus 411 capsulates the frame received from the storage apparatus 100 so that it can be transmitted through the IP network. The apparatus 411 transfers the encapsulated frame to the apparatus 415. The apparatus 415 receives the encapsulated frame from the apparatus 411. The apparatus 415 obtains a frame from the capsulated frame. The apparatus 415 transfers the frame to the storage apparatus 200. The other apparatus 412, 413, 414, 416, 417, 418 execute the same process so that they transfers a frame.

[Storage apparatus] Next, the storage apparatus 100 and the storage apparatus 200 will be explained. The storage apparatus 100 includes a controller 110, a memory 120, a disk array 130, and ports 151, 152, 153, 154, and 160. The storage apparatus 200 has the same arrangement as that of the storage apparatus 100 and includes a controller 210, a memory 220, a disk array 230, and ports 251, 252, 253, 254, and 260. The controller 110, the memory 120, the disk array 130, and the ports 151, 152, 153, 154, and 160 of the storage apparatus 100 have the same functions as those of the controller 210, the memory 220, the disk array 230, and the ports 251, 252, 253, 254, and 260 of the storage apparatus 200, respectively. In the embodiment, the storage apparatus 100 is a copy source storage apparatus, and the storage apparatus 200 is a copy destination storage apparatus. The respective arrangements of the storage apparatus 100 will be explained below. Note that, since the storage apparatus 200 is the same as the storage apparatus 100, explanation of the storage apparatus 200 is omitted. The storage apparatuses may select a transmission port to be connected to a receiving port of a data transmission destination based on a throughput, they can efficiently transfer data.

The controller 110 acts as a data read/write module 111, a data copy module 112, a path selection module 113, a throughput detection module 114, and the like by executing a control program 121 stored in the memory 120. The data read/write module 111 executes a data read process or a data write process of the disk array 130 in response to a command from, for example, the server 301 or the server 302. The data copy module 112 executes a data copy process by the REC to be described later, to, for example, the storage apparatus 200. The path selection module 113 executes a process for selecting a path when data is transmitted to, for example, the storage apparatus 200. The throughput detection module 114 periodically calculates the throughputs of the respective paths connecting to, for example, the storage apparatus 200.

The memory 120 stores the control program 121 executed by the controller 110, the information of the result of a data copy process while it is being executed, cash information temporarily stored until data is stored in a disk array, amount-of-data information 122 of the data of each path being transmitted, throughput information 123 of each path, threshold value information 124, a table 170, and the like. The memory 120 is, for example, a random access memory (RAM), a read only memory (ROM), and the like. The table 170 stores the amount of data of each path being transmitted, the transfer efficiency degradation value, and the total value of the amount of the data being transmitted and the transfer efficiency degradation value. The amount-of-data information 122 of the data being transmitted denotes the amount of the data being transmitted from the storage apparatus 100 to the storage apparatus 200. A transmitted amount of the data is determined from the difference between the amount of data transmitted by the storage apparatus 100 and the amount of data corresponding to a reception completion report received from the storage apparatus 200. The amount of data of the embodiment may use a block as a unit of data treated by the storage apparatus as a reference. One block is, for example, 512 bytes. The storage apparatus transfers data by a block having a size of 512 bytes. The data amount of the embodiment denotes the number of blocks transmitted from the storage apparatus 100 to the storage apparatus 200.

The disk array 130 stores the data to which the server 100 accesses. The disk array 130 is composed of, for example, a plurality of disk apparatuses 140. Note that the memory 120 and the disk array 130 are storage modules in which information can be stored.

The ports 151, 152, 153, and 154 are interfaces for inputting and outputting data between the storage apparatus 100 and outside. The ports 151, 152, 153, and 154 of the embodiment are connected to the data transmission/reception storage apparatus 200 through the network 400. The respective ports 151, 152, 153, and 154 of the embodiment can set a plurality of paths 401, respectively. The paths 401 connect the ports 151, 152, 153, and 154 of the storage apparatus 100 to the ports 251, 252, 253, and 254 of the storage apparatus 200 through the network 400. Since the paths 401 between the storage apparatus 100 and the storage apparatus 200 have a multiple arrangement, even if data cannot be transferred by one path, it can be transferred by another path. The port 160 is a terminal which can be connected to the server 301 and the server 302.

A unique worldwide name (WWN) is previously given to the respective ports of the storage apparatus 100 of the embodiment and the respective ports of the storage apparatus 200 of the embodiment. A WWN is an address of 64 bits (8 bytes) and cannot be changed. The storage apparatus 100 has path information. The path information is the information which can specify the relation between the transmission port information of a data transmission source and the reception port of a data reception destination. The storage apparatus 100 stores the connecting relation between the WWNs of the respective ports 151, 152, 153, and 154 and the respective ports 251, 252, 253, and 254 of the storage apparatus 200 as, for example, path information. One port of the storage apparatus 100 can be connected to a plurality of ports of the storage apparatus 200. For example, the port 151 can be connected to the ports 251, 252, 253, and 254. Accordingly, the path information as to the port 151 denotes the path information of the port 151 and the port 251, the port 151 and the port 252, the port 151 and the port 253, and the port 151 and the port 254.

The server 301 and the server 302 are, for example, work stations, main frames, and the like. When the server 301 and the server 302 execute an application program, they use various data. The data used by the server is stored in the storage apparatus 100 and the storage apparatus 200. The server 301 and the server 302 access to the storage apparatus 100 and the storage apparatus 200. The storage apparatus 100 and the storage apparatus 200 execute a process for reading data stored in the disk apparatuses 140 or a process for writing data to the disk apparatuses 140 according to an access from the server 301 or the server 302. Further, the server 301 and the server 302 instruct the storage apparatus 100 and the storage apparatus 200 to execute an REC process.

[REC] Here, an operation of the REC executed between the storage apparatuses will be explained. The REC transmits data making use of, for example, an SCSI-FCP (Small Computer System Interface Fibre Channel Protocol) as one of protocol mapping layers of an FC-4 layer. In the SCSI-FCP, data is transmitted and received between the storage apparatus 100 and the storage apparatus 200 using the frames of FCP_CMND, FCP_XFER_RDY, FCP_DATA, and FCP_RDY. The FCP_CMND (FCP Command) is a frame when a command is issued. The FCP_CMND is the frame which is transferred first by the SCSI-FCR The FCP_XFER_RDY (FCP Ready) is a frame transmitted by the storage apparatus 200 to the storage apparatus 100 to notify that preparation for receiving data is finished. The FCP_DATA (FCP Data) is information transmitted from the storage apparatus 100 to the storage apparatus 200. The information includes data as a target of the REC. The FCP-RSP (FCP Response) is status information transmitted by the storage apparatus 200 to the storage apparatus 100.

The REC is one of functions for copying data stored in a disk array between the storage apparatuses. The storage apparatus 100 can copy data to the storage apparatus 200 by REC without making use of the servers 301, 302. A unit of the REC is a continuous region in the disk array of the storage apparatus. The unit of the REC of the embodiment is a block. When data regions to be copied are continuous, the REC may also use a continuous block obtained by integrating a plurality of continuous blocks as a unit. It is assumed, for example, that the continuous block is data of 256 kbytes obtained by integrating the plurality of continuous blocks. Since the continuous block has a large amount of data to be transferred, when the amount of data which can be transferred by the network is reduced (when a band width is narrowed), a delay time is liable to be increased.

The REC is specifically executed by the following procedure. The server 301 or the server 302 transmits an REC start command to the storage apparatus 100. The server 301 or the server 302 transmits parameter information, for example, copy source data region information, copy destination region information, and the like to the storage apparatus 100 as the REC start command. The storage apparatus 100 starts a copy in response to the command from the server 301 or the server 302. The controller 110 acts as the data copy module 112 by executing the control program 121. Note that it is assumed that a region to which the data copied by the REC is stored is previously set to the storage apparatus 200. The storage apparatus 100 physically copies the data, which is stored in the disk array 130, to the region of the disk array 230 of the storage apparatus 200. The controller 110 transmits the frame, which includes the identification information of the storage apparatus 200, the data information of a target to be transmitted, the identification information of the storage apparatus 100, path information, and the like, to the storage apparatus 200.

When the storage apparatus 200 obtains the data from the storage apparatus 100, it stores the data in the memory 120 as cache information and stores the data in the region of the disk apparatus 240 of the target of the disk array 230 corresponding to the copy destination region information. The storage apparatus 100 executes a copy of the overall region instructed by the parameter from the server 301 or the server 302. When a write command is issued to the region whose copy has been finished from the server 301 or the server 302, the storage apparatus 100 transfers the write command to the copy destination storage apparatus 200. When the overall region of a target to be copied has been copied, the data stored in the disk array 130 and the data stored in the disk array 230 are placed in an equivalent state. This state is called an equivalent keep state. In the equivalent keep state, the storage apparatus 100 and the storage apparatus 200 execute a data read/write process so that the equivalent state is kept. When a data write command is received from the server 301 or the server 302 in the equivalent keep state, the storage apparatus 100 transfers data as to the write command to the storage apparatus 200.

In the execution procedure of the REC, two copies having a different property are operated. The operation of a first copy is an operation from a time at which the start of execution of the REC is received from the serve to a time at which the equivalent keep state is achieved. The operation of a second copy is a copy operation executed corresponding to a write command from the server. When a plurality of paths connect between the storage apparatus 100 and the storage apparatus 200, the controller 110 selects a data transmission path and executes a copy process by the REC. A manager previously registers the information of the paths which can be used by the REC to the storage apparatus 100.

Next, a path selection process executed by the controller 110 when the plurality of paths connect between the storage apparatus 100 and the storage apparatus 200 will be explained. In the embodiment, it is assumed that path information between the storage apparatus 100 and the storage apparatus 200 is previously defined. The controller 110 selects a path of each data to be transmitted. First, a procedure, by which the controller 110 selects a path through which it transfers data by the throughput of the path, will be explained, and thereafter a procedure, by which the controller 110 selects a path through which it transfers data by an amount of data and a transfer efficiency degradation value while the path is being transmitted, will be explained.

[Procedure of throughput detection process] Here, a throughput detection process executed by the controller 110 of the storage apparatus 100 will be explained. The controller 110 acts as a throughput detection module 115 by executing the control program 121. The throughput of the embodiment is determined by, for example, the amount of data transmitted from the storage apparatus 100 to the storage apparatus 200 per unit of time. The controller 110 determines the throughput of each path used by the REC between the storage apparatus 100 and the storage apparatus 200. The controller 110 calculates the throughput at each predetermined time (M). The predetermined time (M) is set to a time interval which can avoid the reduction of a data transfer speed caused by that the throughput is frequently calculated. For example, the controller measures the throughput once per several seconds. Note that, in the embodiment, the controller 110 does not calculate the throughput of a path which is not used in a predetermined time. At the time, the controller 110 sets the throughput of a path whose throughput is not calculated to an estimated value to. For example, the controller 110 sets the estimated value to the average value of the throughputs in a past predetermined period. Otherwise, the controller 110 sets the estimated value to the average value of the throughputs of the other paths whose estimated values are calculated.

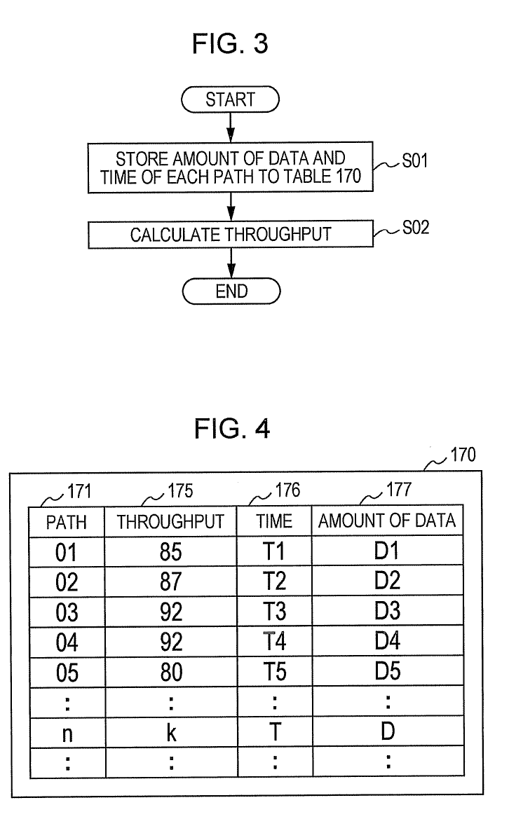

FIG. 3 is a flowchart of the throughput detection process. The controller 100 calculates the throughput of each path at each predetermined time (M) by the following procedure.

The controller 110 stores the amount of data transmitted from the storage apparatus 100 to the storage apparatus 200 and the time needed to transmit the data in the table 170 of the memory 120 for each path (S01).

FIG. 4 illustrates an arrangement example of the table 170 for storing the relation between a path and a throughput. The table 170 includes a path 171, a throughput 175, a time 176, and a data amount 177. The path 171 is information including, for example, the address information of a data transmission source port and the address information of a data transmission destination port. The data amount 177 is the amount of data transmitted to the storage apparatus 200 by the controller 110 using the respective paths.

The time 176 is the time needed to transmit data to the storage apparatus. The time 176 is the time passed from the time, at which the storage apparatus 100 begins to transmit data to the storage apparatus 200, to the time at which the storage apparatus 100 obtains the information of a data reception report from the storage apparatus 200. Further, when the storage apparatus 200 can detect the time at which it receives the data from the storage apparatus 100, it is also possible for the storage apparatus 200 to transmit the received time information of the time at which it receives data to the storage apparatus 100 together with the data reception report. For example, the storage apparatus 100 stores the transmission time information of the time at which it transmits data to the storage apparatus 200 in the memory 120. The storage apparatus 200 transmits the received time information denoting that the data reception thereof is finished to the storage apparatus 100 together with the data reception report. The storage apparatus 100 can calculate the time needed to transmit the data from the transmission time information and the data received time information received from the storage apparatus 200.

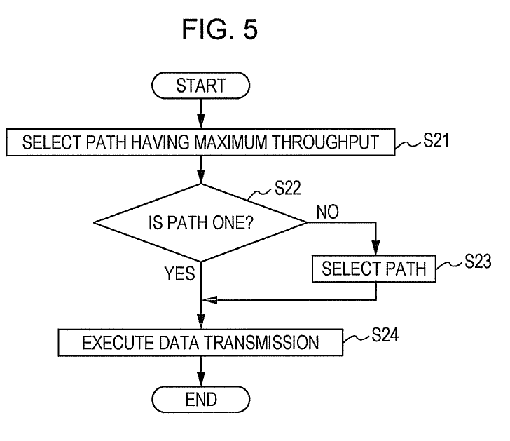

The throughput 175 is calculated from the data amount 177 and the time 176. The controller 110 calculates the throughput by dividing the total value of the transferred amounts of data by the total value of the times needed to transmit the data (S02). The controller 110 stores the calculated throughput in the table 170 of the memory 120.

[Procedure of transmission path selection process] Here, a transmission path selection process executed by the controller 110 of the storage apparatus 100 will be explained. FIG. 5 is a flowchart of the transmission path selection process. The controller 110 acts as a path selection module 113 by executing the control program 121. The controller 110 selects, for example, the path 171 having the maximum throughput 175 (S21).

The controller 110 determines whether the number of paths extracted at S21 is 1 or not (S22). When the number of extracted paths is 2 or more (plural) (S22: No), the controller 110 selects one path from the plurality of extracted paths (S23). At S23, the controller 110 selects a path, for example, at random. When the number of the paths extracted at S21 is 1 (single) (S22: Yes) or after the path is selected at S23, the controller 110 transmits data using the extracted path or the selected path (S24).

The throughput of the path between the storage apparatus 100 and the storage apparatus 200 just after the REC is started is not known. In this case, the controller 110 selects a path for transmitting data by, for example, the order of path identification numbers.

[Amount of data being transmitted and throughput] Next, a process, in which the controller 110 selects a path for transmitting data by the total value of an amount of data being transmitted and a transfer efficiency degradation value will be explained. The controller 110 determines the total value of the amount of data being transmitted and the transfer efficiency degradation value. The total value denotes the degree of delay of the time needed to a data transfer between the storage apparatus 100 and the storage apparatus 200 to an ordinary time. When the total value is smaller, the controller 110 transmits a block by selecting a path whose total value is minimized.

“The data being transmitted” of the embodiment denotes the data which is being transferred from the storage apparatus 100 to the storage apparatus 200. “The data being transmitted” is the data which is transmitted by the storage apparatus 100 to the storage apparatus 200 and the reception completion report of which is not received by the storage apparatus 100 from the storage apparatus 200. “The amount of data being transmitted” of the embodiment is the difference between the amount of data transmitted by the storage apparatus 100 to the storage apparatus and the amount of data having received by the storage apparatus 200. The controller 110 stores the amount of data of each path being transmitted to a memory. When the plurality of paths connect between the storage apparatuses, the controller 110 increase “the amount of data being transmitted” of each path each time it transmits data to the storage apparatus 200. When the amount of data being transmitted is denoted by, for example, the number of blocks, the controller 110 increase a value corresponding to the number of transmitted blocks. On the completion of data transmission, the controller 110 decreases “the amount of data being transmitted” relating to the path. When the amount of data being transmitted is denoted by, for example, the number of blocks, the controller 110 decreases a value corresponding to the number of transmitted blocks. The controller 110 detects the completion of data transmission by the reception completion report from the storage apparatus 200. When, for example, the plurality of paths exist between the storage apparatus 100 and the storage apparatus 200, the controller 110 prepares a counter to each of the paths. When the controller 110 transmits data using a path, it increments the counter of a target path. On the completion of data transmission, the controller 110 decrements the counter. The value of the counter is the amount of data being transmitted. Further, the data between the storage apparatus 100 and the storage apparatus 200 is transmitted as a predetermined amount of data, i.e., using a block as a unit. The controller 110 may use, for example, the number of transmitted blocks as the amount of data being transmitted. In general, since the WAN has a data transfer amount per unit time smaller than that of the fibre channel, the amount of data being transmitted is liable to increase.

When the controller 110 issues a data transmission command, since the controller 110 refers to the amount of data of each path being transmitted, it can transmit data by selecting a path having a minimum amount of data being transmitted. As a result, a load can be dispersed between the storage apparatus 100 and the storage apparatus 200. However, when the load is dispersed paying attention only to the amount of data being transmitted, there is a possibility that the controller 110 issues a data transmission command also to a path which temporarily has a small throughput. For example, a transfer of data between other apparatuses, which use of a WAN line, may affect a path. Since the amount of data transferred by a path having a small throughput is reduced, a time needed to transfer the data is increased. The controller 110 transmits data to be transmitted next to the storage apparatus 200 without waiting to receive replay information to the data having transmitted to the storage apparatus 200.

When the data transmission command is issued to the path which temporarily has a small throughput, the remaining capacity of the path is reduced. When no replay is returned from the storage apparatus 200 even a predetermined time passes after data is transmitted thereto, the storage apparatus 100 determines a time out has occurred. The storage apparatus 100 has such a function that it determines that a path in which, for example, a time out is repeatedly occurs, is defective and that it is not used in a data transfer executed thereafter. Accordingly, a path which temporarily has a small throughput may not be used in a communication between the storage apparatuses. Thus, the controller 110 selects a data transfer path by the throughputs of the respective paths.

[Procedure of transfer efficiency degradation value detection process] A procedure for detecting a transfer efficiency degradation value will be explained here. The transfer efficiency degradation value is determined depending on a throughput value. A decrease of the throughput value increases the value of the transfer efficiency degradation value. When the transfer efficiency degradation value is determined from the throughput, the transfer efficiency degradation value can be added to “the amount of data being transmitted” to be described later. When “the amount of data being transmitted” has a smaller value, it has a higher data transfer efficiency. In contrast, when “the throughput” has a larger value, it has a higher data transfer efficiency. When “the transfer efficiency degradation value” determined from a throughput has a smaller value, it has a higher data transfer efficiency. Accordingly, an optimum path is detected by the total of “the amount of data being transmitted” and “the transfer efficiency degradation value”. The manager sets a plurality of threshold values to the throughput value and determines the transfer efficiency degradation values to the respective threshold values.

Further, each time the controller 110 transfers data, it executes a transmission path selection process to be described later. When it takes a time for the controller 110 to determine the optimum path, there is a possibility that the data transfer efficiency is reduced. Accordingly, the controller 110 determines the optimum path in a short time. Since the controller 110 can simply calculate the transfer efficiency degradation value, it can determine the optimum path in a short time.

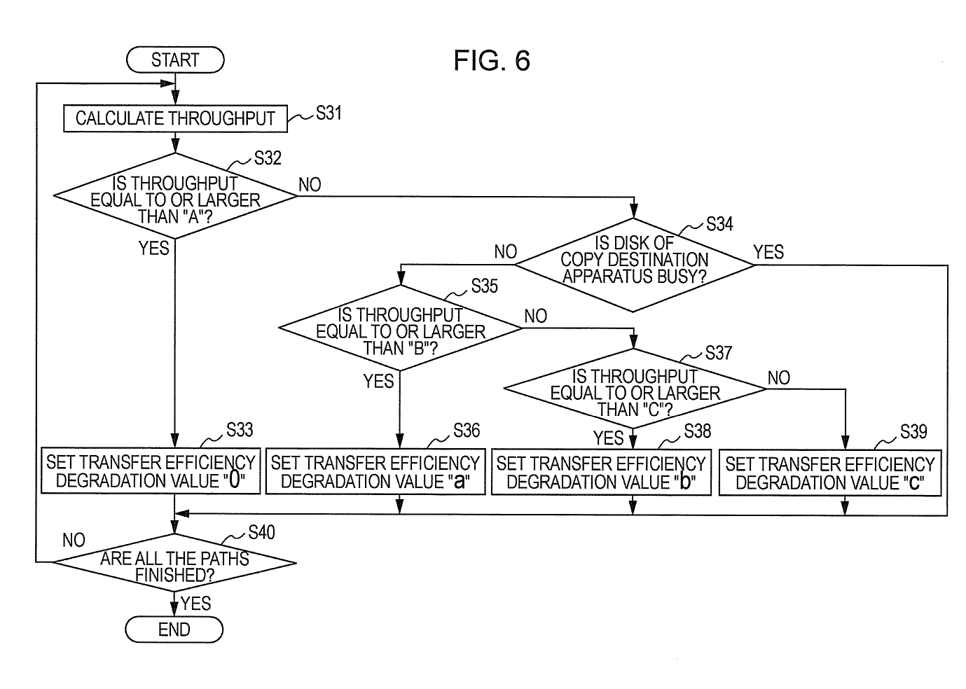

Note that, in the embodiment, the controller 110 does not calculate the throughput of a path which is not used within a predetermined time. At the time, the controller 110 sets, for example, the transfer efficiency degradation value of a path whose throughput is not calculated to “0”. The throughput of the path whose throughput is not calculated is found when the controller 110 uses the path to transmit data. FIG. 6 is a flowchart of a transfer efficiency degradation value detection process. The controller 100 calculates the throughput of each path at each predetermined time (M) (S31). The controller 110 calculates the throughput by, for example, a procedure of FIG. 3.

A first threshold value (A), a second threshold value (B), and a third threshold value (C) are threshold values for determining the state of a path by the magnitude of a throughput. The first threshold value (A), the second threshold value (B), and the third threshold value (C) are previously set by the manager. The first threshold value (A) is a value larger than the second threshold value (B), and the second threshold value (B) is a value larger than the third threshold value (C). In the embodiment, the transfer efficiency degradation value, which is added when the throughput value is smaller than the respective threshold values, is increased. A transfer efficiency degradation value “a” is smaller than a transfer efficiency degradation value “b”, and the transfer efficiency degradation value “b” is smaller than a transfer efficiency degradation value “c”. Since a path having a small transfer efficiency degradation value has a high throughput, it can be easily used to transmit data.

The controller 110 determines whether or not the throughput of a path exceeds the first threshold value (A) (S32). That is, the controller 110 determines whether or not a delay occurs in a path using the thus set first threshold value (A). A threshold value for determining whether or not a delay occurs is previously set by the manager. When a throughput is equal to larger than the first threshold (A) (S32: Yes), the controller 110 sets “0” to the transfer efficiency degradation value of a path (S33). In contrast, when the throughput is less than the first threshold (A) (S32: No), the controller 110 determines whether a path delays or the process of the storage apparatus 200 delays.

The controller 110 determines whether or not the storage apparatus 200 is in a disk busy state (S34). The disk busy is the state in which, for example, the data read process or the data write process of the storage apparatus 200 delays because a write or a read frequently occurs to the disk apparatus. A reason why the storage apparatus 200 determines whether or not the disk busy state occurs when the throughput is less than the first threshold value (A) resides in that if whether or not the disk busy state occurs is determined first through all the paths, a load is applied on the storage apparatus.

The controller 110 detects the state of the storage apparatus 200 by, for example, the following method. The controller 110 transmits a data write command or a data read command to the disk array 230 to the storage apparatus 200. At the same time, the controller 110 transmits a command, which does not affect the disk array 230, to the storage apparatus 200. The command, which does not affect the disk array 230, is, for example, a command for instructing the storage apparatus 200 only to respond to a reception.

The controller 110 receives a response to a command which relates to the disk array 230 and a response to a command which does not relate to the disk array 230 from the storage apparatus 200. The controller 110 determines the state of the storage apparatus 200 by the difference of the times until it obtains responses. For example, the manager previously determines a predetermined time for determining whether or not the storage apparatus 200 is in the disk busy state. When the controller 110 obtains the response to the command which relates to the disk array 230 after the predetermined time passes since it obtains the response to the command which does not relate to the disk array 23, the controller 110 determines that the storage apparatus 200 is placed in the busy state. In contrast, when a predetermined time difference doe not exist until the controller 110 obtains the response to the command which relates to the disk array 230 after it obtains the response to the command which does not relate to the disk array 230, the controller 110 determines that a delay occurs to a path.

Note that the copy destination storage apparatus 200 may have a function for detecting whether or not it is in the disk busy state by itself. In this case, the storage apparatus 100 transmits a query whether or not the storage apparatus 200 is in the disk busy state to the storage apparatus 200. The storage apparatus 200 may determine whether or not it is in the disk busy state and transmit a result of the deterioration to the storage apparatus 100.

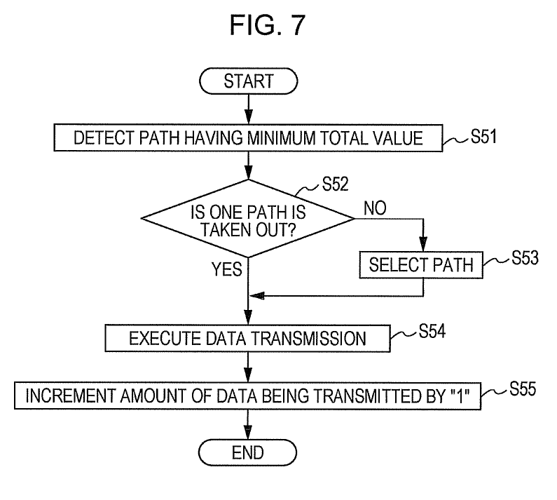

When the storage apparatus 200 is in the disk busy state (S34: Yes), the controller 110 finishes the process. This is because it is considered that a throughput is reduced by that the storage apparatus 200 is in the disk busy state. In contrast, when the storage apparatus 200 is not in the disk busy (S34: No), the controller 110 determines whether or not a throughput is equal to or larger than the second threshold value (B) (S35). When the throughput is equal to or larger than the second threshold value (B) (S35: Yes), the controller 110 sets “a” to the transfer efficiency degradation value of the path (S36). When the throughput is equal to or smaller than the second threshold value (B) (S35: No), the controller 110 determines whether or not the throughput is equal to or larger than the third threshold value (C) (S37). When the throughput is equal to or larger than the third threshold value (C) (S37: Yes), the controller 110 sets “b” to the transfer efficiency degradation value of the path (S38). When the throughput is less than the third threshold value (C) (S37: No), the controller 110 sets “c” to the transfer efficiency degradation value of the path (S39). The embodiment is arranged such that the manager previously sets the plurality of threshold values for switching the transfer efficiency degradation value according to the value of a throughput. Note that a method of calculating the transfer efficiency degradation value is not limited to the above method. For example, the controller 11 may calculate the transfer efficiency degradation value from the inverse number of the value of a throughput. The controller 110 determines whether or not the steps from S01 are finished as to all the paths (S40). When the steps are finished as to all the paths (S40: Yes), the controller 110 finishes the process. In contrast, when the steps are not finished as to all the paths (S40: No), the controller 110 executes the step at S31 and the subsequent steps as to the path whose process is not finished.

[Procedure of Transmission Path Selection Process] FIG. 7 is a flowchart of a transmission path selection process. The controller 110 acts as the path selection module 113 by executing the control program 121.

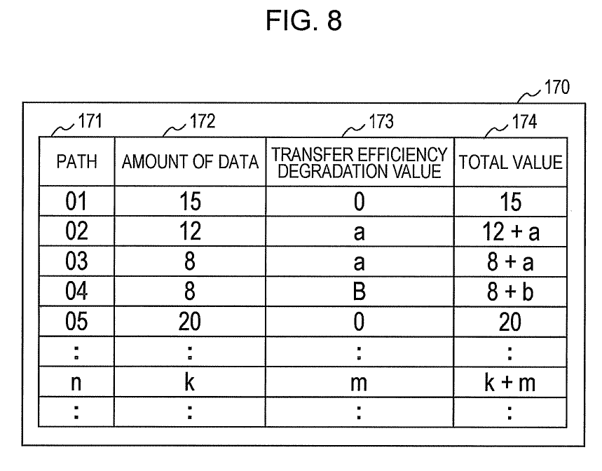

The controller 110 determines the total value of the amount of data and the transfer efficiency degradation value of each path and extracts a path having a minimum total value (S51). FIG. 8 is an arrangement example of a table denoting the total value of an amount of data of a path being transmitted and a transfer efficiency degradation value. The table 170 includes the path 171, the amount of data 172 being transmitted, the transfer efficiency degradation value 173, and the total value 174 as the total of the amount of data 172 being transmitted and the transfer efficiency degradation value 173. It is estimated that the path having the minimum total value 174 is a path optimum to a data transfer at the time. The controller 110 selects the path having the minimum total value 174.

The controller 110 selects path information used for the data transfer by the total value 174 of the table 170. When the storage apparatus 100 transmits data to the storage apparatus 200 first, the throughputs of the respective paths for connecting the storage apparatus 100 to the storage apparatus 200 are not known. An initial value “0” is set to the transfer efficiency degradation value 173.

The controller 110 determines whether or not the number of paths extracted at S51 is 1 (S52). When the number of the extracted paths is 2 or more (plural) (S52: No), the controller 110 selects one path from the plurality of extracted paths (S53). The controller 110 selects a path, for example, at random. When the number of the paths extracted at S51 is 1 (single) (S52: Yes) and after the path is selected at S53, the controller 110 transmits data to the storage apparatus 200 using the extracted path or the selected path (S54). The controller 110 increments “1” to the amount of data which is related to the path used for the data transfer and is being transmitted (S55). When, for example, the amount of data being transmitted is determined by the number of blocks, the controller 110 adds the number of blocks to be transmitted to the amount of data being transmitted.

When the controller 110 obtains response information denoting that it has received data from the storage apparatus 200, it decrements “1” from the amount of data 172 of the table 170 being transmitted. When, for example, the amount of data being transmitted is determined by the number of blocks, the controller 110 subtracts the number of blocks having been transmitted from the amount of data being transmitted. Note that the controller 110 of the embodiment selects a path through which data is transmitted to the storage apparatus 200 by the total value of the amount of data being transmitted and the transfer efficiency degradation value. The controller may select the path through which data is transmitted to the storage apparatus 200 from the amount of data being transmitted and a throughput.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. An apparatus for storing data, the apparatus connectable to another apparatus via a plurality of paths over a network, comprising:
a plurality of ports each of which is connectable to one end of each of the paths;
a memory for storing information of the plurality of paths to the another apparatus; and
a processor for executing a process comprising:
monitoring throughput of each of the plurality of paths by receiving a message from the another apparatus indicative of an amount of data successfully received at an interval,
determining at least one of the ports for transmitting data on the basis of the monitored throughput, and
transmitting data from the determined port to the another apparatus.

2. The apparatus according to claim 1, wherein the monitoring of the process calculates the throughput at each predetermined time.

3. The apparatus according to claim 1:
wherein the process includes detecting an amount of data being transmitted by calculating the difference between the amount of data transmitted by the storage apparatus to the another apparatus and the amount of data having received by the another storage apparatus,
wherein the determining at least one of the ports transmits data on the basis of the monitored throughput and the amount of data being transmitted.

4. The apparatus according to claim 1:
wherein the process further including determining whether the another apparatus is placed in a busy state,
wherein the determining at least one of the ports transmits data on the basis of the monitored throughput and the determined busy state.

5. A method for controlling an apparatus for storing data, the apparatus connectable to another apparatus via a plurality of paths over a network, the apparatus including a plurality of ports each of which is connectable to one end of each of the paths and a memory for storing information of the plurality of paths to the another apparatus, the method comprising:
monitoring throughput of each of the plurality of paths by receiving a message from the another apparatus indicative of an amount of data successfully received at an interval,
determining at least one of the ports for transmitting data on the basis of the monitored throughput, and
transmitting data from the determined port to the another apparatus.

6. The method according to claim 6, wherein the monitoring calculates the throughput at each predetermined time.

7. The apparatus according to claim 6:
further including detecting an amount of data being transmitted by calculating the difference between the amount of data transmitted by the storage apparatus to the another apparatus and the amount of data having received by the another storage apparatus,
wherein the determining at least one of the ports transmits data on the basis of the monitored throughput and the amount of data being transmitted.

8. The apparatus according to claim 1:
wherein the process further including determining whether the another apparatus is placed in a busy state,
wherein the determining at least one of the ports for transmits data on the basis of the monitored throughput and the determined busy state.
